(19) United States
(12) Patent Application Publication
(10) Pub. No.: US 2026/0358295 A1
(43) Pub. Date: Nov. 12, 2026

(54) NON-DESTRUCTIVE TESTING OF A TUBULAR WORKPIECE

(71) Applicant: Evident Canada, Inc., Quebec (CA)

(72) Inventors: Hubert Chalifoux-Bellemarre, Québec (CA); David-Alexandre Roy-Chevalier, Lévis (CA)

(73) Assignee: Evident Canada, Inc., Quebec (CA)

(21) Appl. No.: 19/672,917

(22) Filed: May 11, 2026

Related U.S. Application Data
(60) Provisional application No. 63/802,838, filed on May 9, 2025.

(51) Int. Cl. G01N 27/904; G01N 27/9013

(52) U.S. Cl. CPC G01N 27/904; G01N 27/9013

(57) ABSTRACT

An inspection system and method for concurrent non-destructive testing of an inner surface and an outer surface of a tubular workpiece are disclosed. The inspection system may include a frame having a floating plate movably coupled to a frame body, at least one outer probe assembly mounted to the frame at a position radially outward from the tubular workpiece, at least one inner probe assembly mounted to the frame at a position radially inward from the tubular workpiece, and a plurality of independent actuators each operable to actuate a respective probe assembly. The floating plate can passively compensate for radial run-out of the tubular workpiece during inspection. The independent actuators may concurrently urge the outer and inner probe assemblies against the respective surfaces of the tubular workpiece, enabling concurrent acquisition of NDT data for both surfaces in a single inspection pass.

### CROSS REFERENCE TO RELATED APPLICATION

This application claims the benefit of priority under 35 U.S.C. § 119(e) to U.S. Provisional Patent Application No. 63/802,838, titled CONTEMPORANEOUS EDDY CURRENT INSPECTION OF INTERIOR-FACING AND OUTSIDE SURFACES, filed on May 9, 2025, the entire disclosure of which is hereby incorporated by reference in its entirety.

### BACKGROUND

### Technical Field

This document pertains generally, but not by way of limitation, to non-destructive testing, and more particularly, to systems and methods for performing inspection of inner and/or outer surfaces of a tubular workpiece (e.g., shells, pipes, rings, or other tubular components) by concurrently positioning probes for inspecting the inner and/or outer surfaces.

### Discussion of Art

Non-destructive testing (NDT) can refer to use of one or more different techniques to inspect regions on or within an object, such as to ascertain whether flaws or defects exist, or to otherwise characterize the object being inspected. One class of non-destructive testing can include use of an eddy current testing approach where electromagnetic energy is applied to the object and resulting induced currents on or within the object are detected, with the values of a detected current (or a related impedance) providing an indication of the structure of the object under test, such as to indicate a presence of a crack, void, porosity, or other inhomogeneity. Generally, an eddy current (EC) sensor includes one or more sensor elements such as inductive coils that can be excited using an alternating current (AC) source. Such coils (or other electromagnetic sensing elements such as hall sensors) can be used for receiving a signal indicative of an induced eddy current on or within the structure. When multiple such coils are arranged in an array configuration, the resulting eddy current array (ECA) can enable inspection of a broader area of a workpiece surface in a single pass.

ECA techniques can be applied to non-destructive testing of tubular workpieces (e.g., including shells, pipes, rings, and tubular components), which can require reliable detection of surface and near-surface defects on both inner and outer surfaces. ECA techniques can detect surface and near-surface discontinuities without requiring chemical contact agents and without inducing material damage. Various approaches to inspecting tubular workpieces can present challenges, including the inability to concurrently inspect both the inner and outer surfaces, inconsistent probe-to-surface contact due to radial run-out of the workpiece during rotation, and asymmetric force application on workpieces that may induce wall-tilt and NDT signal variability.

### SUMMARY

In one aspect, the present disclosure provides an inspection system for concurrent non-destructive testing of an inner surface and an outer surface of a tubular workpiece. The inspection system may include a frame, at least one outer probe assembly, at least one inner probe assembly, and a plurality of independent actuators. The frame may receive the tubular workpiece. Each of the at least one outer probe assembly may be mounted to the frame at a position radially outward from the tubular workpiece. Each outer probe assembly may include an outer NDT sensor supported by an outer arm that is actuatable to move the outer NDT sensor toward the outer surface of the tubular workpiece. Each of the at least one inner probe assembly may be mounted to the frame at a position radially inward from the tubular workpiece. Each inner probe assembly may include an inner NDT sensor supported by an inner arm that is actuatable to move the inner NDT sensor outward toward the inner surface of the tubular workpiece. Each of the plurality of independent actuators may be operable to actuate a respective one of the outer and inner arms such that the corresponding outer and inner NDT sensors are concurrently positioned to scan the outer and inner surfaces of the tubular workpiece.

In one aspect, the present disclosure provides a probe assembly for non-destructive testing of an inner surface of a tubular workpiece. The probe assembly may include a first arm, a second arm, an NDT sensor, a first actuator, and a second actuator. The first arm may be positionable radially inward from the tubular workpiece and actuatable toward the inner surface of the tubular workpiece. The second arm may be positionable radially inward from the tubular workpiece on an opposing side of the tubular workpiece from the first arm and actuatable toward the inner surface of the tubular workpiece. The NDT sensor may be supported by the first arm and may be operable to acquire NDT data from the inner surface of the tubular workpiece. The first actuator may be operably coupled to the first arm to actuate the first arm toward the inner surface of the tubular workpiece. The second actuator may be operably coupled to the second arm to actuate the second arm toward the inner surface of the tubular workpiece. The first and second actuators may be independently operable, and concurrent actuation of the first and second arms toward the inner surface may generate counterbalancing forces on the inner surface of the tubular workpiece.

In one aspect, the present disclosure provides a method for inspecting an inner surface and an outer surface of a tubular workpiece. The method may include positioning the tubular workpiece relative to an inspection system, independently actuating a plurality of independent actuators, and acquiring NDT data for the outer and inner surfaces of the tubular workpiece. The inspection system may include a frame, at least one outer probe assembly mounted to the frame at a position radially outward from the tubular workpiece, at least one inner probe assembly mounted to the frame at a position radially inward from the tubular workpiece, and a plurality of independent actuators each dedicated to a respective one of the outer and inner probe assemblies. The independently actuating may include independently actuating, by the plurality of independent actuators, each outer probe assembly toward the outer surface of the tubular workpiece and each inner probe assembly toward the inner surface of the tubular workpiece. The acquiring NDT data may include acquiring NDT data for the outer and inner surfaces of the tubular workpiece via NDT sensors of the outer and inner probe assemblies.

### BRIEF DESCRIPTION OF THE DRAWINGS

FIG. 1 is a perspective view of an inspection system for concurrent non-destructive testing of an inner surface and an outer surface of a tubular workpiece, according to at least one embodiment of the present disclosure.

FIG. 2A is a side view of the inspection system of FIG. 1 showing outer probe assemblies in an unactuated position, according to at least one embodiment of the present disclosure.

FIG. 2B is a side view of the inspection system of FIG. 1 showing the outer probe assemblies in an actuated position, according to at least one embodiment of the present disclosure.

FIG. 3A is a top view of the inspection system of FIG. 1 showing inner probe assemblies in an unactuated position, according to at least one embodiment of the present disclosure.

FIG. 3B is a top view of the inspection system of FIG. 1 showing the inner probe assemblies in an actuated position, according to at least one embodiment of the present disclosure.

FIG. 4 is a perspective view of the inspection system of FIG. 1 with components removed to illustrate the floating plate and carriage assemblies, according to at least one embodiment of the present disclosure.

FIG. 5 is a perspective view of an example NDT sensor, according to at least one embodiment of the present disclosure.

FIG. 6 is a plan view of an example flexible circuit of an NDT sensor, according to at least one embodiment of the present disclosure.

FIG. 7 is a side view illustrating an axial offset arrangement of inner probe assemblies, according to at least one embodiment of the present disclosure.

FIG. 8 is a side view illustrating an axial offset arrangement of outer probe assemblies, according to at least one embodiment of the present disclosure.

FIG. 9 is a flowchart illustrating a method for concurrently inspecting an inner surface and an outer surface of a tubular workpiece, according to at least one embodiment of the present disclosure.

### DESCRIPTION

The present disclosure provides various embodiments of a system, a method, and a probe assembly for non-destructive testing of a tubular workpiece. In certain embodiments, the system includes a frame capable of receiving the tubular workpiece, at least one outer probe assembly and at least one inner probe assembly mounted to the frame, and a plurality of independent actuators each operable to actuate a respective probe assembly toward a corresponding surface of the tubular workpiece. Each outer probe assembly can include an outer NDT sensor supported by an outer arm that is actuatable toward the outer surface of the tubular workpiece, and each inner probe assembly can include an inner NDT sensor supported by an inner arm that is actuatable toward the inner surface of the tubular workpiece. The independent actuators enable the outer and inner NDT sensors to be concurrently positioned to scan the outer and inner surfaces of the tubular workpiece (e.g., enabling concurrent acquisition of NDT data for the outer and inner surfaces via the NDT sensors). In certain embodiments, first and second inner arms may be positionable on opposing sides within the tubular workpiece and independently actuatable toward the inner surface such that concurrent actuation generates counterbalancing forces on the inner surface of the tubular workpiece.

Various approaches to testing tubular workpieces can present challenges. One challenge is the inability to concurrently inspect both the inner surface and the outer surface of a tubular workpiece using NDT sensors in a single inspection pass. For example, in some approaches, a single probe may be inserted into a bore of the tubular workpiece to inspect the inner surface only, with a separate operation being required to inspect the outer surface. These sequential operations can increase total inspection cycle time and reduce throughput in high-production-rate manufacturing environments. Embodiments of the system and method disclosed herein can address this challenge by providing at least one outer probe assembly and at least one inner probe assembly, each actuated by independent actuators, such that the outer and inner NDT sensors are positioned to concurrently scan the outer and inner surfaces of the tubular workpiece in a single inspection pass.

Another challenge associated with testing tubular workpieces can result from inconsistent probe-to-surface contact. For example, approaches using manual probe placement against a rotating workpiece may not be capable of achieving the throughput desired for modern high-rate production lines. These approaches may also introduce operator-dependent variability in probe contact quality and signal amplitude. Moreover, radial movement (e.g., radial run-out, in which the axis of rotation of the tubular workpiece is offset from the geometric center of the tubular workpiece, causing the workpiece surface to move radially relative to the inspection system as the workpiece rotates) of the tubular workpiece relative to the inspection system during axial workpiece rotation can cause inconsistent probe-to-surface contact, degrading NDT signal quality. Embodiments of the system disclosed herein can address these challenges by employing independent actuators each operable at a determined pressure such that actuation of the outer and/or inner arms causes each of the outer and inner NDT sensors to be urged against the respective surfaces of the tubular workpiece at a substantially constant contact force, without requiring manual probe placement or active closed-loop pressure control. Because each actuator independently maintains the determined pressure throughout the scanning operation, each NDT sensor can passively track variations in the surface profile of the tubular workpiece as it rotates, including variations arising from radial run-out, thereby maintaining consistent probe-to-surface contact and reducing lift-off variation that would otherwise degrade NDT signal quality.

A further challenge related to testing tubular workpieces can arise from asymmetric force application against surfaces of the workpieces. When a single actuator applies force against only one surface of a tubular workpiece at a time, the asymmetric force on the tubular workpiece could induce wall-tilt variations, introducing inconsistencies in the NDT signal. Embodiments of the system and probe assembly disclosed herein can address this challenge via concurrent actuation of inner and/or outer probe assemblies toward the respective inner surface and/or outer surface of the tubular workpiece, such that the resulting contact forces act in opposing directions thereby counterbalancing each other. For example, in embodiments of the probe assembly, first and second inner arms may be positioned radially inward from an inner surface of a tubular workpiece, and the first and second inner arms may be concurrently actuated radially outward toward the inner surface, generating counterbalancing forces on the inner surface that reduce lateral displacement of the tubular workpiece during inspection.

An additional challenge related to testing tubular workpieces can include insufficient longitudinal coverage per inspection pass with available flexible NDT probe lengths, which can necessitate a greater number of axial translation passes to cover the full length of the tubular workpiece and thereby increase the total scanning time per workpiece. Embodiments of the system disclosed herein address this challenge by providing axially offset probe assemblies whose scanning regions partially overlap along a portion of the longitudinal axis of the tubular workpiece, thereby extending the combined coverage zone per pass beyond the axial length of any single NDT sensor.

A further challenge related to testing tubular workpieces can arise from synchronization failures that can occur when a single actuator is shared between multiple probe assemblies. For example, sharing a single actuator between multiple probes can introduce geometric constraints that cause the inner and outer probes to contact the workpiece at different times, creating synchronization requirements that can be difficult to satisfy reliably and that can complicate the control architecture. Embodiments of the system disclosed herein can address this challenge by providing a plurality of independent actuators, each dedicated to a respective probe assembly, eliminating the need for active synchronization logic between probe assemblies.

A "tubular workpiece" may refer to a hollow body having an inner surface defining a bore extending along a longitudinal axis of the tubular workpiece, and an outer surface disposed radially outward from the inner surface. A wall of the tubular workpiece extends between the inner surface and the outer surface. A tubular workpiece may be characterized by an inner diameter measured at the inner surface and an outer diameter measured at the outer surface, and by a wall thickness defined as the radial distance between the inner surface and the outer surface. A tubular workpiece may have a generally cylindrical shape, or may have other rotationally symmetric or substantially tubular geometries. Non-limiting examples of tubular workpieces include shells (e.g., military shells or cartridge casings), pipes, rings, cylindrical shells, and other tubular components. A tubular workpiece may be a finished component or a pre-formed workpiece that is subject to a subsequent forming operation (e.g., a stretching or drawing process) that alters the wall thickness and/or diameter of the tubular workpiece. Tubular workpieces of different inner diameters, outer diameters, and wall thicknesses may be inspected using embodiments of the systems and methods disclosed herein.

In various embodiments, an inspection system may include a frame, at least one outer probe assembly, at least one inner probe assembly, and a plurality of independent actuators. Each outer probe assembly may include an outer NDT sensor supported by an outer arm, and each inner probe assembly may include an inner NDT sensor supported by an inner arm. Each outer arm and each inner arm may be actuatable by a respective dedicated independent actuator, such that the outer NDT sensors and the inner NDT sensors can be positioned to concurrently scan the outer surface and inner surface of the tubular workpiece.

The frame may be a rigid structure capable of receiving the tubular workpiece. In one embodiment, the frame may include a frame body and a floating plate movably coupled to the frame body. The floating plate may carry the outer probe assemblies and the inner probe assemblies. Because all probe assemblies may be mounted to the floating plate, the floating plate can translate as a unit in response to radial run-out of the tubular workpiece, preserving the relative positions of all probe assemblies with respect to the tubular workpiece and with respect to each other throughout the inspection. This passive compliance can facilitate consistent probe-to-surface contact without requiring active positional feedback or closed-loop control.

In one embodiment, the floating plate may be movably coupled to the frame body via a plurality of bushings, such as rubber or polyurethane bushings, that permit the floating plate to translate along a plane perpendicular to the longitudinal axis of the tubular workpiece. Other bushing materials may be used depending on the application and expected run-out magnitude.

Each outer probe assembly may be mounted to the frame at a position radially outward from the tubular workpiece. The outer arm of each outer probe assembly may be actuatable by its dedicated actuator to move the corresponding outer NDT sensor radially inward toward the outer surface of the tubular workpiece. In certain embodiments, each outer probe assembly may further include a pad positioned between the outer NDT sensor and the outer arm. The pad can distribute contact pressure substantially uniformly across the face of the outer NDT sensor when the outer arm is actuated toward the outer surface. This uniform pressure distribution can reduce lift-off variation between the sensing elements of the outer NDT sensor and the outer surface of the tubular workpiece, which in turn can improve the consistency and amplitude of the NDT signal acquired from the outer surface. In one non-limiting embodiment, the pad may be a fluid-filled compliant body (e.g., a water-bed formed of a silicone body with an internal cavity filled with water) that conforms to the local curvature of the outer surface under the actuation load. Other fluid-filled or compliant pad configurations providing substantially uniform pressure distribution may be used.

Each inner probe assembly may be mounted to the frame at a position radially inward from the tubular workpiece. The inner arm of each inner probe assembly may be actuatable by its dedicated actuator to move the inner NDT sensor radially outward toward the inner surface of the tubular workpiece. In embodiments having at least two inner probe assemblies positioned on opposing sides of the tubular workpiece, the inner arms may be concurrently actuated toward the inner surface such that the resulting contact forces are substantially opposed across the bore of the tubular workpiece, thereby counterbalancing each other. Similarly, in embodiments having at least two outer probe assemblies positioned on opposing sides of the tubular workpiece, the outer arms may be concurrently actuated toward the outer surface such that the resulting contact forces are substantially opposed, thereby counterbalancing each other. This symmetric force application within each set of probe assemblies can reduce wall-tilt and lateral displacement of tubular workpieces, stabilizing the workpiece position relative to the inspection system throughout the scan.

The plurality of independent actuators may each actuate a respective one of the outer arms or the inner arms. The independence of the actuators (e.g., each actuator responding to its own contact-force state without direct mechanical coupling to the other actuators) can enable any of the following functions. First, each probe assembly can independently track the relevant surface of the tubular workpiece as it rotates with radial run-out because each actuator may respond to its own contact force independently. Second, no active synchronization logic may be required to sequence the engagement of the probe assemblies. All actuators may be extended concurrently but independently, and probe contact can be achieved passively when each actuator reaches its determined pressure state. Third, if one probe assembly encounters a locally elevated force condition, only that probe assembly may be affected. The remaining probe assemblies can continue to maintain their contact independently.

In certain embodiments, the actuators may be pneumatic actuators each operable at a determined pressure. The determined pressure may be selected empirically during system commissioning by evaluating the influence of applied pressure on NDT signal quality, identifying a pressure interval that yields acceptable signal amplitude and consistency, and setting the actuators to a static pressure within that interval. The determined pressure may thereby be selected to provide sufficient contact force for reliable NDT signal quality without generating friction forces that would impede workpiece rotation or cause excessive wear of the probe assemblies, and without requiring continuous monitoring of the applied pressure during the inspection. The actuators may be supplied with pressurized air via pneumatic lines connected to a valve bank. In one non-limiting example, the valve bank may include two control valves: a first valve controlling the actuators dedicated to the outer probe assemblies, and a second valve controlling the actuators dedicated to the inner probe assemblies. In other embodiments, a single control valve may extend all actuators simultaneously, or individual control valves may be provided for each actuator. Because each pneumatic actuator may be maintained at the determined pressure throughout the scanning operation without active closed-loop pressure feedback, the system can operate as a passive compliance mechanism that accommodates variations in workpiece diameter, surface contour, and/or radial run-out without operator intervention. This passive compliance can allow the system to accommodate a range of tubular workpiece diameters without mechanical changeover of the probe assemblies or actuators (e.g., reducing setup time when transitioning between workpieces of different diameters).

In certain embodiments, the inspection system is capable of inspecting tubular workpieces of varying diameters without requiring mechanical changeover of the probe assemblies or actuators. Because each independent actuator may be operable at a determined pressure and may passively accommodate variations in workpiece diameter through its available stroke, the same inspection system may be used to inspect a first tubular workpiece having a first inner diameter and a first outer diameter and a second tubular workpiece having a second inner diameter and a second outer diameter different from the first inner diameter and the first outer diameter, respectively. This adaptability can reduce setup time and increase throughput in manufacturing environments where multiple workpiece geometries are produced on the same production line, such as where a pre-formed workpiece and a finished workpiece of different wall thicknesses and diameters are both subject to inspection.

In certain embodiments, the outer NDT sensors and the inner NDT sensors may be eddy current array (ECA) sensors, each including a plurality of eddy current coils arranged in a coil array on a flexible substrate. The flexible substrate can allow the ECA sensor to conform to the curvature of the workpiece surface under the contact force applied by the respective actuator, improving contact uniformity across the full width of the coil array. NDT data signals from the NDT sensors may be routed to external data acquisition and processing equipment via NDT sensor cables.

In certain embodiments, the inspection system may include two outer probe assemblies and two inner probe assemblies, with one independent actuator per probe assembly for a total of at least four independent actuators. The two outer probe assemblies may be axially offset from each other along the longitudinal axis of the tubular workpiece such that the scanning regions of their respective coil arrays overlap along a portion of the longitudinal axis (e.g., only partially overlapping along the longitudinal axis), forming a combined continuous outer coverage zone free of axial gaps. Similarly, the two inner probe assemblies may be axially offset from each other along the longitudinal axis such that the scanning regions of their respective coil arrays partially overlap along a portion of the longitudinal axis (e.g., only partially overlapping along the longitudinal axis), forming a combined continuous inner coverage zone free of axial gaps. The combined coverage zone provided per inspection pass can thereby be greater than the coverage that any single NDT sensor could provide alone, reducing the number of axial translation steps required to inspect a given workpiece length.

In various embodiments, the present disclosure provides a probe assembly for non-destructive testing of an inner surface of a tubular workpiece. The probe assembly may include a first arm positionable radially inward from the tubular workpiece and actuatable toward the inner surface of the tubular workpiece, and a second arm positionable radially inward from the tubular workpiece on an opposing side of the tubular workpiece from the first arm and actuatable toward the inner surface of the tubular workpiece. An NDT sensor may be supported by the first arm and may be operable to acquire NDT data from the inner surface of the tubular workpiece. A first actuator may be operably coupled to the first arm to actuate the first arm toward the inner surface of the tubular workpiece, and a second actuator may be operably coupled to the second arm to actuate the second arm toward the inner surface of the tubular workpiece. The first and second actuators may be independently operable, and concurrent actuation of the first and second arms toward the inner surface can generate counterbalancing forces on the inner surface of the tubular workpiece, as described further herein. The probe assembly may be incorporated into embodiments of the disclosed inspection system, or may be used independently for applications requiring inner surface inspection of a tubular workpiece.

In certain embodiments, the probe assembly may further include a second NDT sensor supported by the second arm. The second NDT sensor may be operable to acquire NDT data from the inner surface of the tubular workpiece concurrently with the NDT sensor supported by the first arm. The first and second arms may be axially offset from each other along the longitudinal axis of the tubular workpiece such that the scanning regions of the respective NDT sensors overlap along a portion of the longitudinal axis, forming a combined continuous inner coverage zone as described further herein.

In certain embodiments, the NDT sensor of the probe assembly may be an eddy current array (ECA) sensor including a coil array on a flexible substrate, as described further herein. Where the probe assembly includes a second NDT sensor on the second arm, the second NDT sensor may likewise be an ECA sensor including a coil array on a flexible substrate.

In certain embodiments, the probe assembly may further include a film covering the NDT sensor, with the NDT sensor being interposed between the film and the first arm. The film can serve as a protective and low-friction interface layer between the NDT sensor and the inner surface of the tubular workpiece during inspection, reducing friction between the NDT sensor and the inner surface as the tubular workpiece rotates relative to the probe assembly. In one non-limiting example, the film may be a polytetrafluoroethylene (PTFE) film having a thickness of less than approximately 0.020 inches. Other low-friction polymer films providing similar protective and interfacial function may be used. The film may be held in tension over the outward-facing surface of the NDT sensor by lateral fasteners (e.g., clamps) that engage the first arm. The lateral fasteners may be formed of a low-friction material, such as brass or another low-friction metal alloy, selected to wear preferentially relative to the material of the tubular workpiece so as to minimize surface marking or damage to the inner surface of the tubular workpiece during rotation.

In certain embodiments, the probe assembly may further include one or more safety features configured to reduce pinching hazards associated with the actuation of the first arm and/or the second arm. For example, the probe assembly may include side skirts disposed adjacent to the first arm and/or the second arm, and/or a top cap disposed over an upper portion of the first arm and/or the second arm. The side skirts and top cap can reduce the exposure of shear planes created by the relative motion of the first and second arms during actuation, thereby mitigating the risk of pinching injury to an operator during workpiece loading, unloading, or maintenance operations.

In certain embodiments, a groove may be defined in an outward-facing surface of the first arm, and the NDT sensor may be seated within the groove. The probe assembly may further include a backing disposed in the groove and behind a rear surface of the NDT sensor. The backing may be operable to cause the NDT sensor to protrude outward from the first arm toward the inner surface of the tubular workpiece, such that the sensing face of the NDT sensor extends beyond the outward-facing surface of the first arm and can make contact with the inner surface when the first arm is actuated. In one embodiment, the backing may be a silicone cushion disposed behind the NDT sensor within the groove. The silicone cushion may have a thickness selected to produce a controlled protrusion distance (e.g., approximately 2 millimeters), causing the NDT sensor and any overlying film to protrude slightly outward from the first arm as a raised contact surface. When the first arm is actuated toward the inner surface of the tubular workpiece, the silicone cushion may compress under the resulting contact force, providing limited compliance at the probe-to-surface interface. This localized compliance can be less than the compliance provided by a fluid-filled pad (e.g., the water-bed described herein for the outer probe assemblies), but can nonetheless improve conformance of the NDT sensor to the inner surface and reduce lift-off variation across the coil array, thereby enhancing NDT signal quality. Other compliant or semi-rigid backing materials providing similar protrusion and limited compliance characteristics may be used. Where the probe assembly includes a second NDT sensor on the second arm, the second arm may likewise define a groove with a backing disposed behind the second NDT sensor.

In certain embodiments, the first actuator and the second actuator of the probe assembly may be pneumatic actuators each operable at a determined pressure, as described further herein. The determined pressure may be selected such that actuation of the first and second arms causes the NDT sensors supported by the first and second arms to be urged against the inner surface of the tubular workpiece at a substantially constant contact force. The independent operability of the first and second actuators can ensure that each arm independently tracks the inner surface of the tubular workpiece as it rotates, without direct mechanical coupling between the two arms.

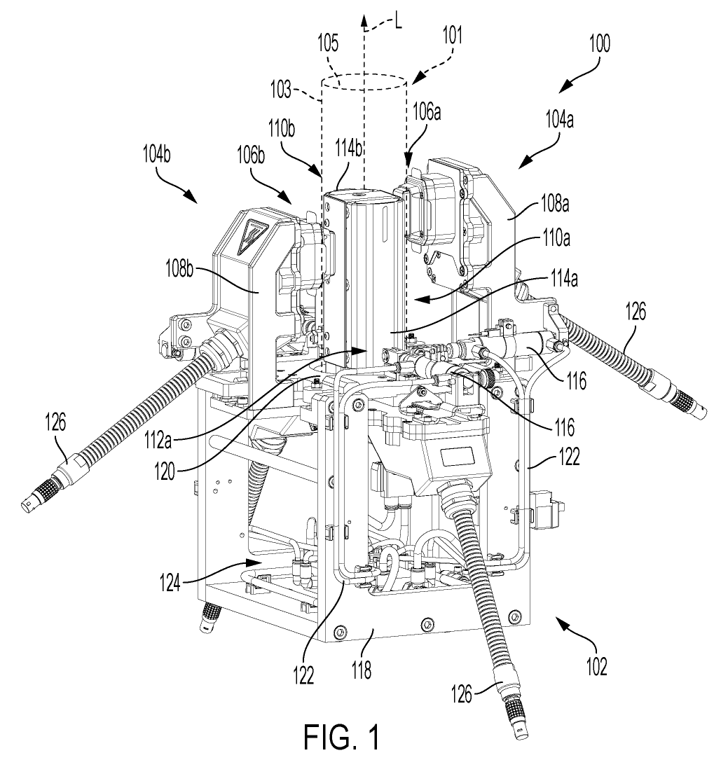

FIGS. 1-8 illustrate embodiments of an inspection system 100 for NDT of a tubular workpiece. It will be appreciated that aspects of the inspection system 100 disclosed with respect to FIGS. 1-8 may be implemented in any of the other embodiments of the inspection system, the method, or the probe assemblies disclosed herein, and vice versa.

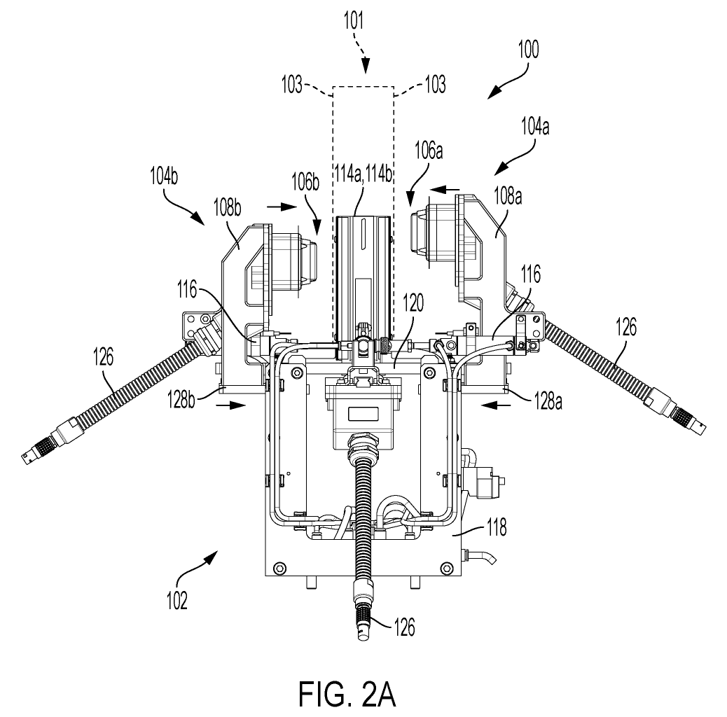

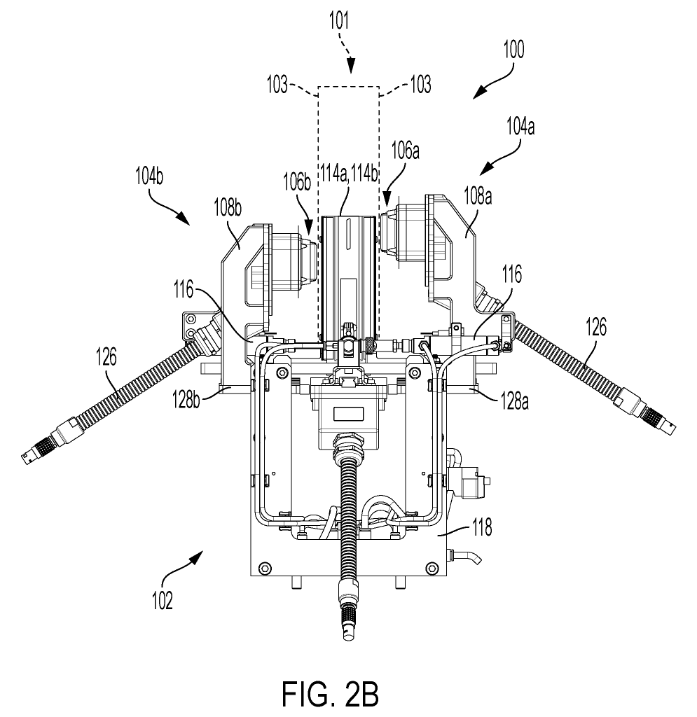

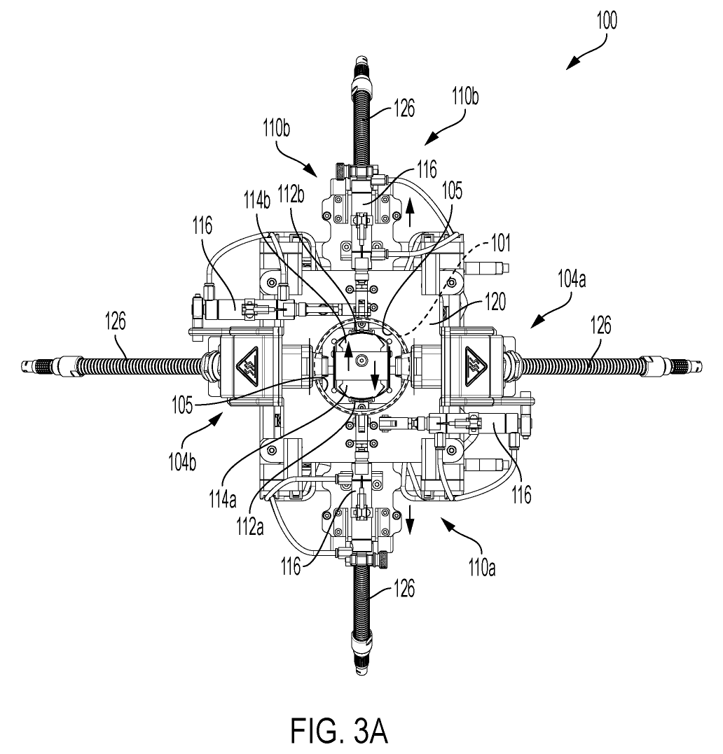

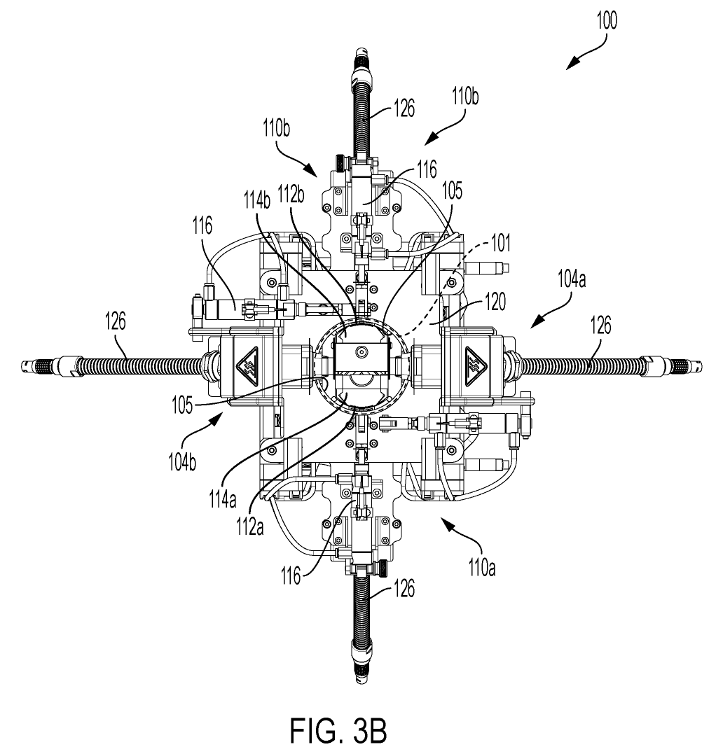

Referring primarily to FIG. 1, the inspection system 100 may include a frame 102, two outer probe assemblies 104a, 104b, two inner probe assemblies 110a, 110b, a plurality of actuators 116, pneumatic lines 122, a valve bank 124, and NDT sensor cables 126. The inspection system 100 can receive a tubular workpiece 101 and concurrently scan an outer surface 103 and an inner surface 105 of the tubular workpiece 101 using outer NDT sensors 106a, 106b (FIGS. 2A and 2B) and inner NDT sensors 112a, 112b (FIGS. 3A and 3B) while the tubular workpiece 101 rotates relative to the inspection system 100 about the longitudinal axis L.

The frame 102 may be a rigid structural assembly that can support the components of the inspection system 100. The frame 102 may include a frame body 118 and a floating plate 120 movably coupled to the frame body 118. The outer probe assemblies 104a, 104b and the inner probe assemblies 110a, 110b may be mounted to the floating plate 120 such that all probe assemblies move together as a unit when the floating plate 120 translates relative to the frame body 118.

The first outer probe assembly 104a may include a first outer NDT sensor 106a supported by a first outer arm 108a. The second outer probe assembly 104b may include a second outer NDT sensor 106b supported by a second outer arm 108b. The first inner probe assembly 110a may include a first inner NDT sensor 112a supported by a first inner arm 114a. The second inner probe assembly 110b may include a second inner NDT sensor 112b supported by a second inner arm 114b.

Each of the outer arms 108a, 108b and inner arms 114a, 114b may be coupled to a respective dedicated independent actuator 116. The actuators 116 may be pneumatic actuators supplied with pressurized air via pneumatic lines 122 from a valve bank 124. NDT data signals from the outer NDT sensors 106a, 106b and the inner NDT sensors 112a, 112b may be routed to external data acquisition equipment via NDT sensor cables 126.

In one embodiment, the tubular workpiece 101 may be presented to the inspection system 100 by a robotic gripper that rotates the tubular workpiece 101 at a controlled speed while the inspection system 100 remains stationary. In an alternative embodiment, the inspection system 100 may be mounted on a linear traversal axis that advances the inspection system 100 along the longitudinal axis L relative to a stationary tubular workpiece 101.

FIGS. 2A and 2B show how the outer probe assemblies 104a, 104b may be actuated such that the outer NDT sensors 106a, 106b can be positioned to concurrently scan the outer surface 103 of the tubular workpiece 101. In FIG. 2A, the outer arms 108a, 108b may be in the retracted position, with the outer NDT sensors 106a, 106b spaced radially outward from the outer surface 103 of the tubular workpiece 101. In this position, the tubular workpiece 101 can be inserted into or removed from the inspection system 100 without interference from the outer probe assemblies 104a, 104b.

In FIG. 2B, the actuators 116 dedicated to the outer probe assemblies 104a, 104b may be actuated, translating the outer arms 108a, 108b radially inward toward the tubular workpiece 101 until the outer NDT sensors 106a, 106b are urged against the outer surface 103 of the tubular workpiece 101 such that the outer NDT sensors 106a, 106b are concurrently positioned to scan the outer surface 103.

Each outer arm 108a, 108b may be independently actuated by its respective dedicated actuator 116. Because the actuators 116 may be independent, the first outer arm 108a and the second outer arm 108b can each independently respond to their respective contact forces with the outer surface 103, allowing each outer probe assembly 104a, 104b to passively track the outer surface 103 through radial run-out variations of the tubular workpiece 101 without direct mechanical coupling between the two outer probe assemblies 104a, 104b.

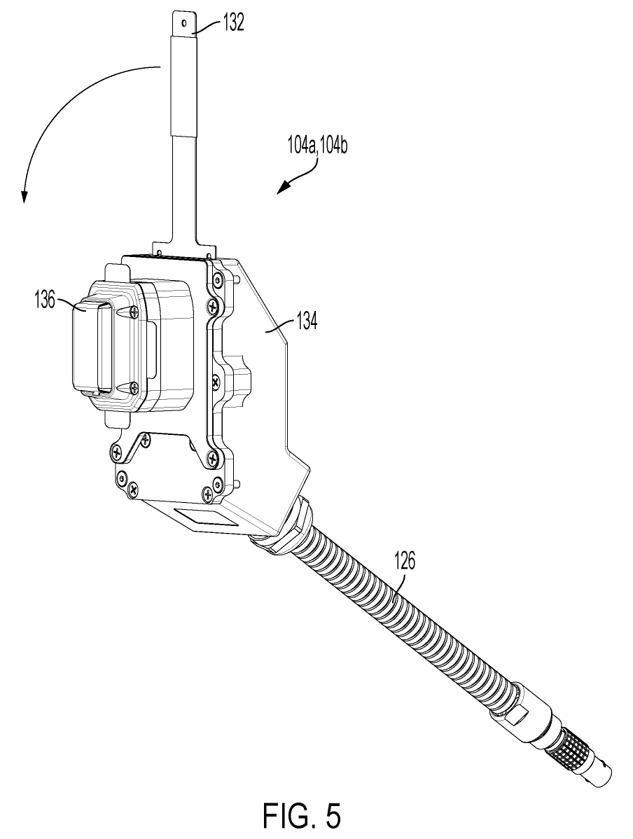

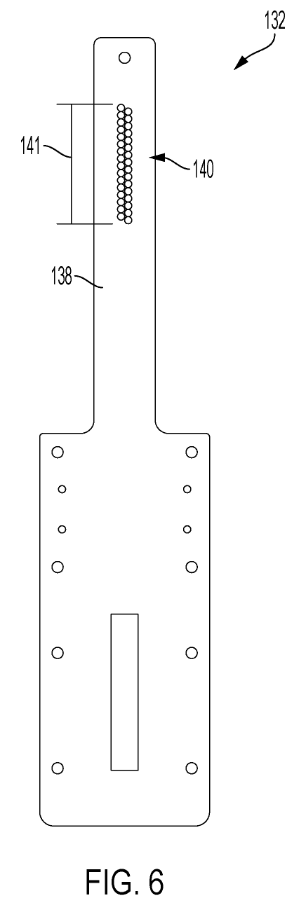

In certain embodiments, each outer probe assembly 104a, 104b may further include a pad 136 disposed between the outer NDT sensor 106a, 106b and the outer arm 108a, 108b. FIG. 5 shows the pad 136. The pad 136 may be a compliant body that distributes contact pressure substantially uniformly across a face of the outer NDT sensor 106a, 106b when the outer arm 108a, 108b are urged against the outer surface 103. The pad 136 is described in further detail below with reference to FIGS. 5 and 6.

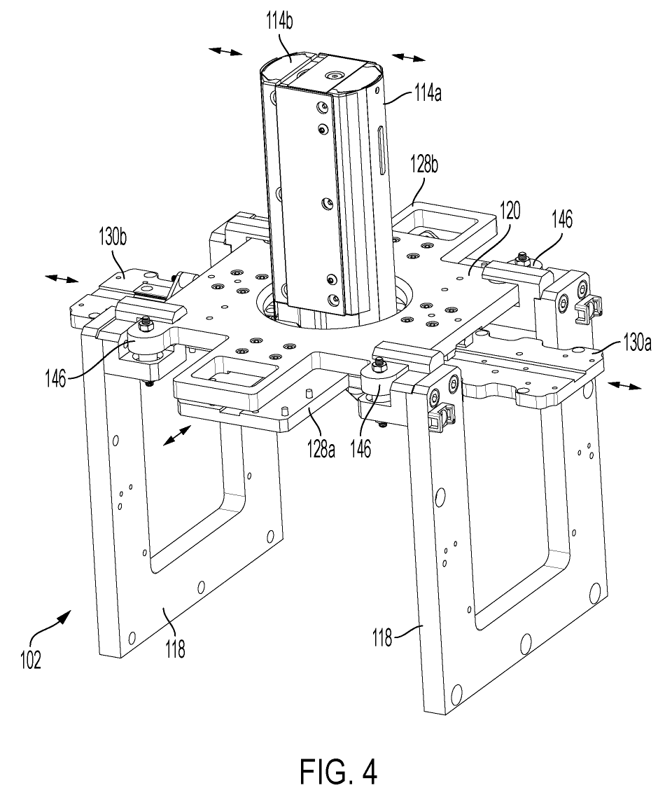

FIG. 4 illustrates the inspection system 100 with various components removed to expose the floating plate 120, the outer arm carriages 128a, 128b, and the inner arm carriages 130a, 130b.

Outer arm carriages 128a, 128b, best shown by FIG. 4, may guide the radial translational motion of the outer arms 108a, 108b toward and away from the outer surface 103 of the tubular workpiece 101. Each outer arm carriage 128a, 128b may be coupled to the respective actuator 116 and can constrain the motion of the outer arm 108a, 108b to a substantially radial direction with respect to the longitudinal axis L of the tubular workpiece 101, reducing off-axis loading on the outer NDT sensor 106a, 106b during engagement.

FIGS. 3A and 3B show how the inner probe assemblies 110a, 110b may be actuated such that the inner NDT sensors 112a, 112b can be positioned to concurrently scan the inner surface 105 of the tubular workpiece 101. In FIG. 3A, the inner arms 114a, 114b may be in the retracted position, with the inner NDT sensors 112a, 112b positioned radially inward from the inner surface 105 of the tubular workpiece 101. In this position, the inner probe assemblies 110a, 110b can be configured not to contact (better?) the tubular workpiece 101, permitting the tubular workpiece 101 to be inserted or removed.

In FIG. 3B, the respective actuators 116 dedicated to the inner probe assemblies 110a, 110b may be actuated, translating the inner arms 114a, 114b radially outward toward the inner surface 105 of the tubular workpiece 101 until the inner NDT sensors 112a, 112b are urged against the inner surface 105 such that the inner NDT sensors 112a, 112b are concurrently positioned to scan the inner surface 105.

The first inner probe assembly 110a and the second inner probe assembly 110b may be positioned on opposing sides of the tubular workpiece 101. When the inner arms 114a, 114b are concurrently actuated outward as shown in FIG. 3B, the contact forces applied by the first inner probe assembly 110a and the second inner probe assembly 110b are directed in substantially opposing radial directions across the bore of the tubular workpiece 101, generating counterbalancing forces on the inner surface 105. These counterbalancing forces can prevent lateral displacement of the tubular workpiece 101 within the inspection system 100 during the scanning operation, stabilizing the workpiece position and maintaining consistent probe-to-surface contact for both inner probe assemblies 110a, 110b throughout the rotational scan.

Each inner arm 114a, 114b may be independently actuated by its respective dedicated actuator 116, providing the same or substantially the same independent contact-force tracking capability described for the outer probe assemblies 104a, 104b above.

Inner arm carriages 130a, 130b, best shown by FIG. 4, can guide the radial translational motion of the inner arms 114a, 114b outward toward the inner surface 105 and inward to the retracted position. Each inner arm carriage 130a, 130b may be coupled to the respective actuator 116 and can constrain the motion of the inner arm 114a, 114b to a substantially radial direction with respect to the longitudinal axis L.

Referring primarily to FIG. 4, and also to FIGS. 2A-3B, the floating plate 120 may be movably coupled to the frame body 118 via a plurality of bushings 146. The bushings 146 may be compliant elements (e.g., rubber or polyurethane bushings) that permit the floating plate 120 to translate in a plane perpendicular to the longitudinal axis L of the tubular workpiece 101. Because all four probe assemblies and their respective actuators 116 may be mounted on the floating plate 120, translation of the floating plate 120 can preserve the relative geometry of all probe assemblies with respect to each other and with respect to the tubular workpiece 101. If the tubular workpiece 101 rotates with radial run-out, the contact forces from the inner probe assemblies 110a, 110b and outer probe assemblies 104a, 104b can cause the floating plate 120 to passively translate to follow the run-out displacement, maintaining concurrent contact of all probe assemblies with the tubular workpiece 101 throughout the full rotation.

The outer arm carriages 128a, 128b may be linear bearing assemblies mounted on the floating plate 120 and oriented to guide radially inward and outward motion of the outer arms 108a, 108b with respect to the longitudinal axis L. Each outer arm carriage 128a, 128b may be coupled to its respective actuator 116 such that actuation of the actuator 116 can translate the outer arm carriage 128a, 128b and thereby drive the outer arm 108a, 108b radially inward to engage the outer surface 103 of the tubular workpiece 101.

The inner arm carriages 130a, 130b may similarly be linear bearing assemblies mounted on the floating plate 120 and oriented to guide radially outward and inward motion of the inner arms 114a, 114b with respect to the longitudinal axis L. Each inner arm carriage 130a, 130b may be coupled to its respective actuator 116 such that actuation of the actuator 116 can translate the inner arm carriage 130a, 130b and thereby drive the inner arm 114a, 114b radially outward to engage the inner surface 105 of the tubular workpiece 101.

FIG. 5 shows an example NDT sensor of the inspection system 100. The NDT sensor may be an eddy current array (ECA) sensor including a flexible circuit 132 and a sensor housing 134. In embodiments of the outer probe assemblies 104a, 104b, the NDT sensor may further include a pad 136 disposed between the flexible circuit 132 and the outer arm 108a, 108b.

The sensor housing 134 may be a rigid or semi-rigid body that supports the flexible circuit 132 and provides structural attachment points for mounting the NDT sensor to the respective outer arm 108a, 108b. The sensor housing 134 may also provide a pathway for routing the NDT sensor cables 126 from the flexible circuit 132 to the external data acquisition equipment. Although FIG. 5 shows an NDT sensor of an outer probe assembly 104a, 104b, the NDT sensors of the inner probe assemblies 110a, 110b may have similar features and may be mounted to the inner arm carriages 130a, 130b (e.g., on the underside of the inner arm carriages 130a, 130b). As discussed further with respect to FIG. 6, the flexible circuit 132 may include a flexible substrate that can conform to a curvature of the outer surface 103 or inner surface 105 of the tubular workpiece 101 under the contact force applied by the respective actuator 116.

In embodiments of the outer probe assemblies 104a, 104b and, the pad 136 may be disposed between the outer arm 108a, 108b and the flexible circuit 132. For example, referring primarily to FIG. 5 and also to FIG. 6, the flexible circuit 132 is shown extending in a generally straight configuration away from the sensor housing 134. A portion of the flexible circuit 132 attached to the sensor housing 134 may be fixed relative to the sensor housing 134, while a remaining portion of the flexible circuit 132 extending away from the sensor housing 134 may be free to bend due to the flexible nature of the flexible circuit 132. A curved arrow in FIG. 5 indicates a folding operation in which the free portion of the flexible circuit 132 is folded downward over the pad 136 such that the coil array 140 covers a face of the pad 136. The pad 136 may be a compliant body that distributes the actuation load from the outer arm 108a, 108b substantially uniformly across the full area of the flexible circuit 132, preventing the flexible circuit 132 from being locally overloaded at the point of contact with the outer arm 108a, 108b and ensuring uniform contact pressure across the coil array 140. In one non-limiting embodiment, the pad 136 may be a water-bed including a silicone body with an internal cavity filled with water; other fluid-filled or compliant pad configurations may be used.

Referring primarily to FIG. 6, the flexible circuit 132 may include a flexible substrate 138, a coil array 140 that defines a scanning region 141. The flexible substrate 138 may be a thin planar sheet of a compliant polymer material on and/or within which the coil array 140 may be fabricated. In one non-limiting example, the flexible substrate 138 may be formed of a polyimide film. The coil array 140 may include a plurality of individually addressable eddy current coils arranged in a regular array pattern across the flexible substrate 138. The specific coil geometry, pitch, and array dimensions may be selected based on the flaw size detection requirement, the workpiece material, and the operating frequency of the ECA instrumentation.

The scanning region 141 may be the area of the flexible circuit 132 covered by the coil array 140 and that contributes to NDT data acquisition during inspection. The scanning region 141 can define the effective axial coverage width of the NDT sensor in the direction of the longitudinal axis L of the tubular workpiece 101. The dimensions of the scanning region 141 may be a function of the selected NDT sensor model and coil array 140 size.

The flexible substrate 138 can allow the coil array 140 to conform to the curvature of the workpiece surface when the NDT sensor is urged against the outer surface 103 or inner surface 105 by the respective actuator 116, as described above.

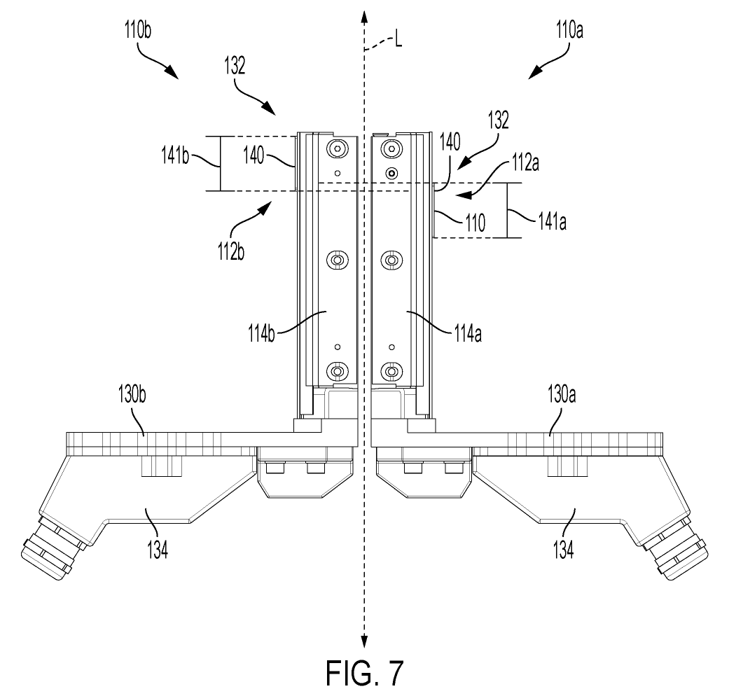

FIG. 7 shows an axial offset arrangement of the two inner probe assemblies 110a, 110b that may be implemented in the inspection system 100. The first inner probe assembly 110a may have a coil array 140 with a corresponding scanning region 141a extending along a first axial zone of the longitudinal axis L of the tubular workpiece 101. The second inner probe assembly 110b may have a coil array 140 with a corresponding scanning region 141b extending along a second axial zone of the longitudinal axis L.

In certain embodiments, each of the inner NDT sensors 112a, 112b may be arranged such that flexible circuit 132 extends over a face of the corresponding inner arm 114a, 114b, and a film may be stretched over the outward-facing surface of the flexible circuit 132 of the inner NDT sensors 112a, 112b and held in tension by lateral clamps that engage the lateral edges of the flexible circuit 132. Thus, each flexible circuit 132 of the inner NDT sensors 112a, 112b may be arranged along a corresponding face of the inner arm 114a, 114b. The film can serve as a protective and low-friction interface layer between the flexible circuit 132 and the inner surface 105 of the tubular workpiece 101 during inspection. In one non-limiting example, the film may be a polytetrafluoroethylene (PTFE) film (e.g., having a thickness of less than approximately 0.020 inches). Other low-friction polymer films providing equivalent protective and interfacial function may be used. The lateral clamps may be formed of a low-friction material selected to wear preferentially relative to the material of the tubular workpiece 101, so as to minimize surface marking or damage to the inner surface 105 during rotation. In one non-limiting example, the lateral clamps may be formed of brass or another low-friction metal alloy. The film and lateral clamps may be designed as replaceable wear parts to maintain inspection performance over the service life of the inner probe assemblies 110a, 110b.

The first inner probe assembly 110a and the second inner probe assembly 110b may be axially offset from each other along the longitudinal axis L such that the scanning region 141a of the first inner probe assembly 110a and the scanning region 141b of the second inner probe assembly 110b overlap along a portion of the longitudinal axis L. This overlap can ensure that there is no axial gap in ECA coverage between the scanning regions 141a and 141b, forming a combined continuous inner coverage zone. The combined inner coverage zone can have an axial extent greater than the axial extent of either individual scanning region 141a or 141b alone.

The axial overlap may be achieved by mounting the flexible circuits 132 of the inner NDT sensors 112a, 112b to the corresponding inner arms 114a, 114b such that the coil arrays 140 may be at axially offset positions along the longitudinal axis L, with the offset distance selected to produce the desired overlap. In one non-limiting example, the offset distance may be less than the axial length of either individual scanning region 141a, 141b, such that the overlap may be only a fraction of each individual scanning region.

The axial overlap arrangement can extend the longitudinal scanning coverage of the inner surface 105 of the tubular workpiece 101 per inspection pass without increasing the radial envelope of the individual inner probe assemblies 110a, 110b. This can reduce the number of axial translation steps required to scan the full length of the inner surface 105 of the tubular workpiece 101, contributing to a reduced total inspection cycle time.

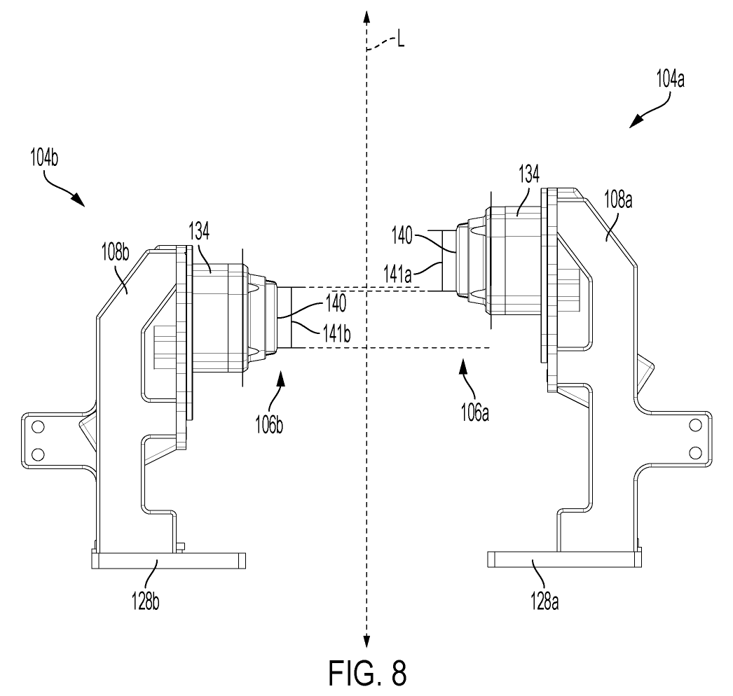

FIG. 8 shows an axial offset arrangement of the two outer probe assemblies 104a, 104b that may be implemented by the inspection system 100. The first outer probe assembly 104a may have a coil array 140 with a corresponding scanning region 141a extending along a first axial zone of the longitudinal axis L of the tubular workpiece 101. The second outer probe assembly 104b may have a coil array 140 with a corresponding scanning region 141b extending along a second axial zone of the longitudinal axis L.

The first outer probe assembly 104a and the second outer probe assembly 104b may be axially offset from each other along the longitudinal axis L such that the scanning region 141a of the first outer probe assembly 104a and the scanning region 141b of the second outer probe assembly 104b overlap along a portion of the longitudinal axis L. This overlap can ensure that there is no axial gap in ECA coverage between the scanning regions 141a and 141b, forming a combined continuous outer coverage zone. The combined outer coverage zone can have an axial extent greater than the axial extent of either individual scanning region 141a or 141b alone.

The axial overlap and combined continuous outer coverage zone can enable a greater portion of the outer surface 103 of the tubular workpiece 101 to be scanned per inspection pass than can be achieved by either individual scanning region 141a or 141b alone, reducing the number of axial translation steps required to scan the full length of the outer surface 103 and thereby contributing to a reduced total inspection cycle time.

As discussed further herein, a robotic arm may translate the tubular workpiece 101 along its longitudinal axis L to facilitate scanning the tubular workpiece 101 along its entire length. In alternative embodiments, the tubular workpiece 101 may be held stationary and the inspection system 100 may be mounted on a linear axis (e.g., a motorized linear slide or rail, a ball screw drive, a lead screw driven by a motor, or a belt-driven linear actuator) that traverses the inspection system 100 along the longitudinal axis L relative to the stationary tubular workpiece 101. A separate rotation mechanism may rotate the tubular workpiece 101 about its own axis, or the inspection system 100 may orbit around the stationary tubular workpiece 101. In one non-limiting example, the outer probe assemblies 104a, 104b may be mounted on a linear axis driven by lead screws and a motor, enabling the outer probe assemblies 104a, 104b to traverse the full length of the tubular workpiece 101 while a separate mechanism performs rotation of the tubular workpiece 101. In a further alternative, a rotation mechanism may be integrated into the inspection system 100 itself (e.g., at a lower portion of the frame 102), such that the inspection system 100 can both support and rotate the tubular workpiece 101 without requiring an external robotic gripper or separate rotator. Such embodiments may be suitable for integration into mechanical inspection lines or for higher-throughput applications where robotic handling is not available.

In an alternative embodiment, the inspection system 100 may include a single outer probe assembly and a single inner probe assembly, each with a respective independent actuator 116. Such an embodiment may provide concurrent inner surface and outer surface inspection capability.

In a further alternative embodiment, the outer probe assemblies may be omitted and the inspection system 100 may include only inner probe assemblies and their respective actuators 116 (e.g., applications requiring inner surface inspection only). In such an embodiment, the probe assembly disclosed herein may be used as a standalone component independently of the full inspection system 100.

In a further alternative embodiment, the inspection system 100 may include more than two outer probe assemblies or more than two inner probe assemblies, distributed around the circumference or along the longitudinal axis of the tubular workpiece 101 (e.g., to increase circumferential or longitudinal coverage per pass and further reduce inspection cycle time).

In a further alternative embodiment, the inspection system 100 may be used to inspect a tubular workpiece 101 at a pre-forming stage of manufacture, prior to a subsequent forming operation (e.g., a stretching or drawing process) that alters the wall thickness and/or diameter of the tubular workpiece 101. Because the independent actuators 116 can passively accommodate variations in workpiece diameter and wall thickness as described herein, the same inspection system 100 may be used to inspect both the pre-formed workpiece and the finished workpiece without mechanical changeover.

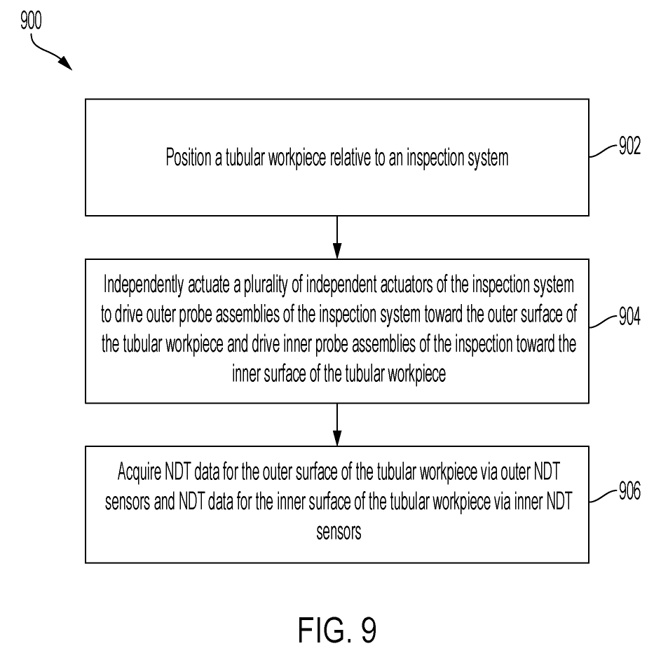

FIG. 9 illustrates a flowchart of a method 900 for concurrently inspecting an inner surface and an outer surface of a tubular workpiece. The method 900 may be implemented using any embodiments of the system or probe assembly disclosed herein.

According to the method 900, the tubular workpiece may be positioned 902 relative to the inspection system. The inspection system may include a frame, at least one outer probe assembly mounted to the frame at a position radially outward from the tubular workpiece, at least one inner probe assembly mounted to the frame at a position radially inward from the tubular workpiece, and a plurality of independent actuators each dedicated to a respective one of the outer and inner probe assemblies. In one non-limiting embodiment, the tubular workpiece may be presented to the inspection system by a robotic gripper. In an alternative embodiment, the inspection system may be advanced along the longitudinal axis L relative to a stationary tubular workpiece.

The plurality of independent actuators may be independently actuated 904, driving each outer probe assembly toward the outer surface of the tubular workpiece and each inner probe assembly toward the inner surface of the tubular workpiece. Each actuator may independently drive its respective probe assembly to contact the workpiece surface at the determined operating pressure, without active synchronization between actuators. The actuators may be concurrently actuated. The concurrent actuation may generate counterbalancing forces on the inner surface and the outer surface of the workpiece.

With all probe assemblies in contact with the tubular workpiece, NDT data may be acquired 906 for the outer surface via the outer NDT sensors and for the inner surface via the inner NDT sensors. The NDT data may be concurrently acquired by the outer NDT sensors and the inner NDT sensors. The tubular workpiece may be rotated through at least 180° about its longitudinal axis L so that NDT data is acquired from the full circumference of both the inner surface and the outer surface of the workpiece within their respective combined axial coverage zones. The acquired NDT data may be routed via NDT sensor cables to external data acquisition and processing equipment for defect analysis.

In one embodiment of the method 900, during the concurrent acquisition 906 of NDT data, rotation or other movement of the tubular workpiece relative to the inspection system may cause the tubular workpiece to push against one or more of the outer probe assemblies or the inner probe assemblies (e.g., due to radial run-out of the tubular workpiece, in which the axis of rotation of the tubular workpiece is offset from the geometric center of the tubular workpiece). The force exerted by the tubular workpiece against the one or more probe assemblies may be transferred through the respective probe assemblies to the floating plate, causing the floating plate to translate laterally relative to the frame body of the frame in a plane perpendicular to the longitudinal axis L. Because all probe assemblies may be mounted to the floating plate, this lateral translation may passively maintain concurrent contact of all probe assemblies with the tubular workpiece throughout the full rotational scan without active positional correction.

In one embodiment of the method 900, the NDT data may be acquired at an initial longitudinal zone of the tubular workpiece during the concurrent acquisition 906 of NDT data. After completing the rotational scan of the initial longitudinal zone, the tubular workpiece may be moved relative to the inspection system along the longitudinal axis L to position a subsequent longitudinal zone of the tubular workpiece within the combined axial coverage zones of the outer probe assemblies and the inner probe assemblies. In one embodiment, the longitudinal movement of the tubular workpiece relative to the inspection system may be performed by a robotic arm. NDT data may then be concurrently acquired for the outer surface and the inner surface at the subsequent longitudinal zone. This scan-and-translate sequence may be repeated as necessary to inspect successive longitudinal zones along the full length of the tubular workpiece.

In one embodiment of the method 900, after acquiring NDT data for a portion of a length of the tubular workpiece, the plurality of actuators may be retracted to disengage the outer probe assemblies from the outer surface and the inner probe assemblies from the inner surface. The tubular workpiece may then be rotated approximately 180° about a transverse axis of the tubular workpiece (e.g., via a robotic arm). The concurrent actuation 904 and the concurrent NDT data acquisition 906 may then be repeated for a remaining portion of the length of the tubular workpiece. This flip-and-rescan approach may enable inspection of the full length of the tubular workpiece from both ends without requiring the inspection system to traverse the full workpiece length from a single end, and without requiring access to both ends of the tubular workpiece simultaneously.

In one embodiment of the method 900, the outer NDT sensors and the inner NDT sensors may be ECA sensors including coil arrays. The two inner probe assemblies may be offset from each other along the longitudinal axis L of the tubular workpiece such that the scanning regions of their respective coil arrays overlap along a portion of the longitudinal axis L. Concurrently acquiring 906 NDT data for the inner surface of the tubular workpiece may include acquiring eddy current response data across the combined coverage zone of the overlapping scanning regions of the first inner probe assembly and the second inner probe assembly.

The detailed description sets forth specific embodiments of the present disclosure. The described embodiments are illustrative and not intended to limit the scope of the claims. The words "first" and "second" are used to distinguish elements of the same type and do not indicate order of preference or temporal sequence unless otherwise stated. The designations "a" and "b" appended to reference numerals are used to distinguish elements of the same or similar type and do not indicate order of preference or temporal sequence unless otherwise stated. All numerical values provided herein, including those relating to dimensions, diameters, pressures, coverage lengths, and material thicknesses, are non-limiting examples provided to illustrate particular implementations. Other values may be used depending on the application, workpiece geometry, and probe specifications.

As used herein, the term "substantially" can refer to a condition that is sufficiently close to a stated condition so as to achieve the same functional result. The degree of deviation from the stated condition that is permissible may depend on the specific context. In general, "substantially" can encompass variations that would be recognized by a person of ordinary skill in the art as being functionally equivalent to the stated condition. For example, "substantially constant" can mean sufficiently constant so as to achieve the intended technical effect, even if minor variations exist, and "substantially uniform" can mean sufficiently uniform so as to achieve the intended technical effect, even if minor non-uniformities exist. Depending on the context, "substantially" may encompass deviations of up to 1%, 5%, 10%, 15%, 20%, or 25% from a stated value or condition, where the permissible degree of deviation is that which a person of ordinary skill in the art would consider to be functionally equivalent to the stated value or condition for the particular application.

As used herein, the terms "about" and "approximately" can be used interchangeably and can refer to a value or condition that is close to the stated value or condition. Unless otherwise indicated or apparent from the context, "about" or "approximately" may encompass a range of variation of up to 1%, 5%, 10%, 15%, 20%, or 25% from the stated value, where the permissible degree of variation is that which a person of ordinary skill in the art would consider to be functionally equivalent to the stated value for the particular application. The use of "about" or "approximately" in connection with a numerical value is intended to include the stated value itself.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following aspects, the terms “including” and “comprising” are open-ended, that is, a system, device, article, composition, formulation, or process that includes elements in addition to those listed after such a term in a claim are still deemed to fall within the scope of that claim. Moreover, in the following aspects, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather,

inventive subject matter may lie in less than all features of a particular disclosed embodiment. Thus, the following aspects are hereby incorporated into the Detailed Description as examples or embodiments, with each aspect standing on its own as a separate embodiment, and it is contemplated that such embodiments can be combined with each other in various combinations or permutations.

What is claimed is:

1. An inspection system for concurrent non-destructive testing of an inner surface and an outer surface of a tubular workpiece, the inspection system comprising:
a frame configured to receive the tubular workpiece;
at least one outer probe assembly mounted to the frame at a position radially outward from the tubular workpiece, wherein each outer probe assembly comprises an outer NDT sensor supported by an outer arm that is actuatable to move the outer NDT sensor toward the outer surface of the tubular workpiece;
at least one inner probe assembly mounted to the frame at a position radially inward from the tubular workpiece, wherein each inner probe assembly comprises an inner NDT sensor supported by an inner arm that is actuatable to move the inner NDT sensor outward toward the inner surface of the tubular workpiece; and
a plurality of independent actuators, each actuator operable to actuate a respective one of the outer and inner arms such that the corresponding outer and inner NDT sensors are concurrently positioned to scan the outer and inner surfaces of the tubular workpiece.

2. The inspection system of claim 1, wherein the frame comprises a frame body and a floating plate movably coupled to the frame body, and the outer and inner probe assemblies are mounted to the floating plate.

3. The inspection system of claim 1, wherein the outer and inner NDT sensors are eddy current array (ECA) sensors each comprising a coil array on a flexible substrate.

4. The inspection system of claim 1, wherein the at least one outer probe assembly comprises a first outer probe assembly and a second outer probe assembly, and the outer NDT sensors of the first outer probe assembly and the second outer probe assembly are offset from each other along a longitudinal axis of the tubular workpiece such that scanning regions of the outer NDT sensors overlap along a portion of the longitudinal axis.

5. The inspection system of claim 1, wherein the at least one inner probe assembly comprises a first inner probe assembly and a second inner probe assembly, and the inner NDT sensors of the first inner probe assembly and the second inner probe assembly are offset from each other along a longitudinal axis of the tubular workpiece such that scanning regions of the inner NDT sensors overlap along a portion of the longitudinal axis.

6. The inspection system of claim 1, wherein the at least one inner probe assembly comprises a first inner probe assembly and a second inner probe assembly positioned on an opposing side of the tubular workpiece from the first inner probe assembly, and concurrent actuation of the inner arms of the first and second inner probe assemblies toward the inner surface of the tubular workpiece generates counterbalancing forces on the inner surface of the tubular workpiece.

7. The inspection system of claim 1, wherein each inner probe assembly further comprises a film covering the corresponding inner NDT sensor, the inner NDT sensor being interposed between the film and the inner arm.

8. The inspection system of claim 1, wherein each outer probe assembly comprises a pad between the outer NDT sensor and the outer arm, and the pad is operable to distribute contact pressure across the outer NDT sensor.

9. The inspection system of claim 1, wherein the plurality of independent actuators are pneumatic actuators each operable at a determined pressure such that actuation of the outer and inner arms causes each of the outer and inner NDT sensors to be urged against the outer and inner surfaces of the tubular workpiece at a substantially constant contact force.

10. A probe assembly for non-destructive testing of an inner surface of a tubular workpiece, the probe assembly comprising:
a first arm positionable radially inward from the tubular workpiece and actuatable toward the inner surface of the tubular workpiece;
a second arm positionable radially inward from the tubular workpiece on an opposing side of the tubular workpiece from the first arm and actuatable toward the inner surface of the tubular workpiece;
an NDT sensor supported by the first arm, the NDT sensor being operable to acquire NDT data from the inner surface of the tubular workpiece;
a first actuator operably coupled to the first arm to actuate the first arm toward the inner surface of the tubular workpiece; and
a second actuator operably coupled to the second arm to actuate the second arm toward the inner surface of the tubular workpiece, wherein the first and second actuators are independently operable, and wherein concurrent actuation of the first and second arms toward the inner surface generates counterbalancing forces on the inner surface of the tubular workpiece.

11. The probe assembly of claim 10, further comprising a second NDT sensor supported by the second arm, the second NDT sensor being operable to acquire NDT data from the inner surface of the tubular workpiece.

12. The probe assembly of claim 10, wherein the NDT sensor is an eddy current array (ECA) sensor comprising a coil array on a flexible substrate.

13. The probe assembly of claim 10, further comprising a film covering the NDT sensor, the NDT sensor being interposed between the film and the first arm.

14. The probe assembly of claim 10, wherein a groove is defined in an outward-facing surface of the first arm, and the NDT sensor is seated within the groove, the probe assembly further comprising a backing disposed in the groove and behind a rear surface of the NDT sensor, wherein the backing is configured to cause the NDT sensor to protrude outward from the first arm toward the inner surface of the tubular workpiece.

15. The probe assembly of claim 10, wherein the first actuator and the second actuator are pneumatic actuators each operable at a determined pressure such that the concurrent actuation of the first and second arms generates the counterbalancing forces on the inner surface of the tubular workpiece.

16. A method for inspecting an inner surface and an outer surface of a tubular workpiece, the method comprising:
positioning the tubular workpiece relative to an inspection system, the inspection system comprising a frame, at least one outer probe assembly mounted to the frame at a position radially outward from the tubular workpiece, at least one inner probe assembly mounted to the frame at a position radially inward from the tubular workpiece, and a plurality of independent actuators each dedicated to a respective one of the outer and inner probe assemblies;
independently actuating, by the plurality of independent actuators, each outer probe assembly toward the outer surface of the tubular workpiece and each inner probe assembly toward the inner surface of the tubular workpiece; and
acquiring NDT data for the outer and inner surfaces of the tubular workpiece via NDT sensors of the outer and inner probe assemblies.

17. The method of claim 16, further comprising passively compensating for radial run-out of the tubular workpiece during NDT data acquisition by allowing a floating plate of the frame to move relative to a frame body of the frame.

18. The method of claim 16, wherein the NDT data is acquired at an initial longitudinal zone of the tubular workpiece, the method further comprising:
moving the tubular workpiece relative to the inspection system to position a subsequent longitudinal zone of the tubular workpiece within a scanning field of the outer and inner probe assemblies; and
acquiring NDT data for the outer and inner surfaces of the tubular workpiece at the subsequent longitudinal zone.

19. The method of claim 18, further comprising:
after acquiring NDT data for a portion of a length of the tubular workpiece, retracting the plurality of independent actuators to disengage the outer and inner probe assemblies from the tubular workpiece;
rotating the tubular workpiece approximately 180° about a transverse axis of the tubular workpiece; and
repeating the independent actuation of the outer and inner probe assemblies and the acquisition of NDT data for a remaining portion of the length of the tubular workpiece.

20. The method of claim 16, wherein the NDT sensors are eddy current array (ECA) sensors comprising coil arrays, wherein the at least one inner probe assembly comprises a first inner probe assembly and a second inner probe assembly offset from each other along a longitudinal axis of the tubular workpiece such that the respective coil arrays of the first and second inner probe assemblies overlap along a portion of the longitudinal axis, and wherein concurrently
acquiring NDT data for the inner surface of the tubular workpiece comprises acquiring eddy current response data across a combined coverage zone of the coil arrays.
